(19) United States
(12) Patent Application Publication
(10) Pub. No.: US 2026/0313743 A1
(43) Pub. Date: Oct. 8, 2026

(54) DEVICES, METHODS, APPARATUSES, AND COMPUTER READABLE MEDIA FOR ADAPTING TRANSMISSION OCCASIONS

(71) Applicant: Nokia Technologies Oy, Espoo (FI)

(72) Inventors: Ahlem KHLASS, Massy (FR); Mads LAURIDSEN, Gistrup (DK); Chunli WU, Beijing (CN); Daniela LASELVA, Klarup (DK)

(73) Assignee: Nokia Technologies Oy, Espoo (FI)

(21) Appl. No.: 19/472,744

(22) PCT Filed: Apr. 6, 2023
(86) PCT No.: PCT/CN2023/086548

§ 371 Date: Oct. 6, 2025

(51) Int. Cl. H04W 76/28; H04W 24/08; H04W 28/02

(52) U.S. Cl. CPC H04W 76/28; H04W 24/08; H04W 28/0278

(57) ABSTRACT

Disclosed are devices, methods, apparatuses, and computer readable media for adapting transmission occasions. An example apparatus for a terminal device may include at least one processor and at least one memory. The at least one memory may store instructions that, when executed by the at least one processor, may cause the terminal device at least to perform: receiving from a network device serving the terminal device, at least one discontinuous communication configuration defining an active period and an inactive period of a cell; receiving from the network device, one or more configurations for transmission occasions, the one or more configurations for transmission occasions being associated with the at least one discontinuous communication configuration; based on activation of a discontinuous communication configuration out of the at least one discontinuous communication configuration, applying at least one configuration for transmission occasions out of the one or more configurations for transmission occasions which is associated with the activated discontinuous communication configuration; and performing communication with the cell according to the applied at least one configuration for transmission occasions.

### TECHNICAL FIELD

Various example embodiments relate to devices, methods, apparatuses, and computer readable media for adapting transmission occasions.

### BACKGROUND

For discontinuous communication, such as discontinuous transmission (DTX), discontinuous reception (DRX), etc. the configuration defines an active period and an inactive (also referred to as a non-active) period of a cell. Such discontinuous communication may be referred to as cell DTX/DRX. Cell DTX/DRX allows the network side to turn off, partially or completely, transmission and reception for user data traffic, control signaling, and reference signals during cell DTX/DRX non-active periods. The network side is able then to enter a sleep state, and thereby save energy during the non-active periods. When operating in the cell DTX/DRX, the cell can follow a periodic pattern of active and non-active periods, the pattern for the cell DRX/DTX may be common for user equipments (UEs) in the cell, and the cell DTX pattern and the cell DRX pattern can be configured separately.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus for the terminal device may include at least one processor and at least one memory. The at least one memory may store instructions that, when executed by the at least one processor, may cause the terminal device at least to perform: receiving from a network device serving the terminal device, at least one discontinuous communication configuration defining an active period and an inactive period of a cell; receiving from the network device, one or more configurations for transmission occasions, the one or more configurations for transmission occasions being associated with the at least one discontinuous communication configuration; based on activation of a discontinuous communication configuration out of the at least one discontinuous communication configuration, applying at least one configuration for transmission occasions out of the one or more configurations for transmission occasions which is associated with the activated discontinuous communication configuration; and performing communication with the cell according to the applied at least one configuration for transmission occasions.

In a second aspect, disclosed is an apparatus for a network device. The apparatus for the network device may include at least one processor and at least one memory. The at least one memory may store instructions that, when executed by the at least one processor, may cause the network device at least to perform: transmitting to a terminal device served by the network device, at least one discontinuous communication configuration defining an active period and an inactive period of a cell; transmitting to the terminal device, one or more configurations for transmission occasions, the one or more configurations for transmission occasions being associated with the at least one discontinuous communication configuration; and based on activation of a discontinuous communication configuration out of the at least one discontinuous communication configuration, applying at least one configuration for transmission occasions out of the one or more configurations for transmission occasions which is associated with the activated discontinuous communication configuration.

In a third aspect, disclosed is a method performed by an apparatus for a terminal device. The method may comprise: receiving from a network device serving the terminal device, at least one discontinuous communication configuration defining an active period and an inactive period of a cell; receiving from the network device, one or more configurations for transmission occasions, the one or more configurations for transmission occasions being associated with the at least one discontinuous communication configuration; based on activation of a discontinuous communication configuration out of the at least one discontinuous communication configuration, applying at least one configuration for transmission occasions out of the one or more configurations for transmission occasions which is associated with the activated discontinuous communication configuration; and performing communication with the cell according to the applied at least one configuration for transmission occasions.

In a fourth aspect, disclosed is a method performed by an apparatus for a network device. The method may comprise: transmitting to a terminal device served by the network device, at least one discontinuous communication configuration defining an active period and an inactive period of a cell; transmitting to the terminal device, one or more configurations for transmission occasions, the one or more configurations for transmission occasions being associated with the at least one discontinuous communication configuration; and based on activation of a discontinuous communication configuration out of the at least one discontinuous communication configuration, applying at least one configuration for transmission occasions out of the one or more configurations for transmission occasions which is associated with the activated discontinuous communication configuration.

In a fifth aspect, disclosed is an apparatus for a terminal device. The apparatus for the terminal device may comprise: means for receiving from a network device serving the terminal device, at least one discontinuous communication configuration defining an active period and an inactive period of a cell; means for receiving from the network device, one or more configurations for transmission occasions, the one or more configurations for transmission occasions being associated with the at least one discontinuous communication configuration; means for based on activation of a discontinuous communication configuration out of the at least one discontinuous communication configuration, applying at least one configuration for transmission occasions out of the one or more configurations for transmission occasions which is associated with the activated discontinuous communication configuration; and means for performing communication with the cell according to the applied at least one configuration for transmission occasions.

In a sixth aspect, disclosed is an apparatus for a network device. The apparatus for the network device may comprise: means for transmitting to a terminal device served by the network device, at least one discontinuous communication configuration defining an active period and an inactive period of a cell; means for transmitting to the terminal device, one or more configurations for transmission occasions, the one or more configurations for transmission occasions being associated with the at least one discontinuous communication configuration; and means for based on activation of a discontinuous communication configuration out of the at least one discontinuous communication configuration, applying at least one configuration for transmission occasions out of the one or more configurations for transmission occasions which is associated with the activated discontinuous communication configuration.

In a seventh aspect, a computer readable medium is disclosed. The computer readable medium may comprise program instructions that, when executed by an apparatus for a terminal device, may cause the terminal device at least to perform: receiving from a network device serving the terminal device, at least one discontinuous communication configuration defining an active period and an inactive period of a cell; receiving from the network device, one or more configurations for transmission occasions, the one or more configurations for transmission occasions being associated with the at least one discontinuous communication configuration; based on activation of a discontinuous communication configuration out of the at least one discontinuous communication configuration, applying at least one configuration for transmission occasions out of the one or more configurations for transmission occasions which is associated with the activated discontinuous communication configuration; and performing communication with the cell according to the applied at least one configuration for transmission occasions.

In an eighth aspect, a computer readable medium is disclosed. The computer readable medium may comprise program instructions that, when executed by an apparatus for a network device, cause the network device at least to perform: transmitting to a terminal device served by the network device, at least one discontinuous communication configuration defining an active period and an inactive period of a cell; transmitting to the terminal device, one or more configurations for transmission occasions, the one or more configurations for transmission occasions being associated with the at least one discontinuous communication configuration; and based on activation of a discontinuous communication configuration out of the at least one discontinuous communication configuration, applying at least one configuration for transmission occasions out of the one or more configurations for transmission occasions which is associated with the activated discontinuous communication configuration.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for adapting transmission occasions according to the example embodiments of the present disclosure.

FIG. 2 shows an exemplary flow for applying SPS/CG configuration(s) according to the example embodiments of the present disclosure.

FIG. 3 shows examples of cell DTX patterns and configurations for SPS occasions.

FIG. 4 shows examples of cell DRX patterns and configurations for CG occasions.

FIG. 5 shows examples of associations between cell DTX configurations and configurations for SPS occasions.

FIG. 6 shows a flow chart illustrating an example method 600 for adapting transmission occasions according to the example embodiments of the present disclosure.

FIG. 7 shows a flow chart illustrating an example method 700 for adapting transmission occasions according to the example embodiments of the present disclosure.

FIG. 8 shows a block diagram illustrating an example device 800 for adapting transmission occasions according to the example embodiments of the present disclosure.

FIG. 9 shows a block diagram illustrating an example device 900 for adapting transmission occasions according to the example embodiments of the present disclosure.

FIG. 10 shows a block diagram illustrating an example apparatus 1000 for adapting transmission occasions according to the example embodiments of the present disclosure.

FIG. 11 shows a block diagram illustrating an example apparatus 1100 for adapting transmission occasions according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

For a UE in connected discontinuous reception (C-DRX) mode, there is an issue that whether some signals/channels can or cannot be expected to receive during the inactive periods of cell DTX. For example, for downlink (DL), whether the C-DRX connected UE needs to monitor physical downlink shared channel (PDSCH) in semi-persistent scheduling (SPS) occasions during inactive periods of cell DTX. For example, for uplink (UL), whether the connected UE is allowed to transmit physical uplink shared channel (PUSCH) in configured grant (CG) occasions during inactive periods of cell DRX.

On one side, it is advantageous to minimize the signals/channels that are transmitted/received during the cell DTX/DRX non-active period such that the network side can enter (deeper) sleep state and achieve network energy saving (NES) gains. On another side, the network side may have strict quality of service (QOS) requirements for the UE to meet. For example, for the UE with delay-stringent data, e.g. voice over internet protocol (VOIP) traffic, the SPS and/or CG is highly beneficial and shall not be postponed during cell DTX/DRX non-active periods.

Example embodiments of the present disclosure provide a solution for adapting transmission occasions, for example, SPS occasions, CG occasions, etc., under cell DTX/DRX without a need for explicit signaling between the UE and the network side. According to example embodiments of the present disclosure, the NES gains may be maximized without compromising the UE QoS performance.

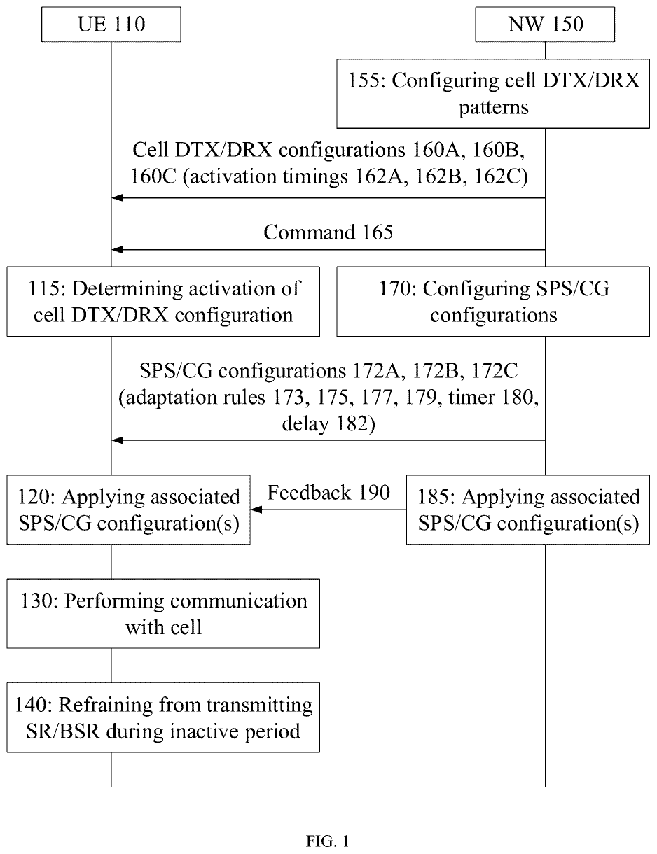

FIG. 1 shows an exemplary sequence diagram for adapting transmission occasions according to the example embodiments of the present disclosure. Referring to the FIG. 1, a UE 110 may represent any terminal device in a wireless network. The UE 110 may be in C-DRX mode. A network device 150 may represent the network side of the wireless network. The network device 150 may function as a cell serving the UE 110. The transmission occasions may be either the SPS occasions for DL or the CG occasions for UL.

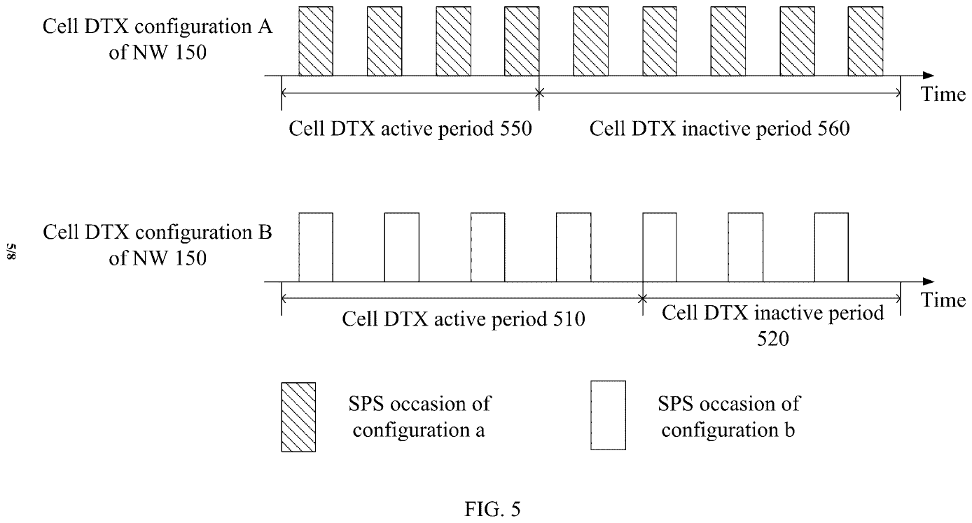

In an operation 155, the network device 150 may configure at least one discontinuous communication configuration defining an active period and an inactive period of the cell. For example, the network device 150 may configure cell DTX/DRX pattern(s) for the UE 110. FIG. 5 shows examples of associations between cell DTX configurations and configurations for SPS occasions. In the FIG. 5, two patterns, cell DTX configuration A and cell DTX configuration B are shown as examples. The cell DTX configuration A defines an active period 550 and an inactive period 560, and the cell DTX configuration B defines an active period 510 and an inactive period 520.

A cell DTX configuration may be associated with at least one SPS configurations. For example, as is shown in the FIG. 5, the cell DTX configuration A may be associated with a configuration a for SPS occasions, and the cell DTX configuration B may be associated with a configuration b for SPS occasions. It may be appreciated that a cell DRX configuration may be associated with at least one CG configuration in a manner similar to the patterns shown in the FIG. 5.

In the descriptions, although expressions of “DTX/DRX” and “SPS/CG” are used, it may be appreciated that the DTX and DRX may be configured and operated separately or together, and the SPS and CG occasions may be configured separately or together. So the DTX and DRX configurations may be identical or different and may be operated together or separately, and the configurations for SPS and CG occasions may be identical or different.

The network device 150 may transmit the cell DTX/DRX configuration(s) to the UE 110. The number of the cell DTX/DRX configured for the UE 110 may be at least one, and at a time only one cell DTX/DRX configuration can be active. In the FIG. 1, cell DTX/DRX configurations 160A, 160B, and 160C are shown as examples. While multiple DTX/DRX configurations may be transmitted to the UE, only one of them may be active at a time.

In the operation 155, the network device 150 may configure activation timing in the cell DTX/DRX configuration. For example, the network device 150 may configure an activation timing 162A in the cell DTX/DRX configurations 160A, an activation timing 162B in the cell DTX/DRX configurations 160B, and an activation timing 162C in the cell DTX/DRX configurations 160C. Based on the activation timing, in an operation 115 the UE 110 may activate the corresponding cell DTX/DRX configuration and deactivate the previous cell DTX/DRX configuration. Alternatively or additionally, the network device 150 may transmit to the UE 110 a command 165 for the UE 110 to activate the corresponding cell DTX/DRX configuration. In this case, in the operation 115 the UE 110 may determine the activation of the cell DTX/DRX configuration based on the command 165 and deactivate the previous cell DTX/DRX configuration. For example, when the UE 110 is applying the cell DTX/DRX configuration 160A, if the activation timing 162B arrives or the UE 110 receives the command 165 to activate the cell DTX/DRX configuration 160B, the UE 110 will determine the activation of the cell DTX/DRX configuration 160B and deactivate the cell DTX/DRX configuration 160A.

In an operation 170, the network device 150 may configure one or more configurations for SPS/CG occasions, and at a time only one SPS/CG configuration can be active. A cell DTX/DRX configuration may associate with at least one configuration for SPS/CG occasions. As with the DTX/DRX configurations, only one configuration for the SPS/CG may be active at a time, and the active configuration for the SPS/CG may be associated with the active configuration for the DTX/DRX, as described herein. Additionally, the network device 150 may configure a configuration for SPS/CG occasions associated with a situation that no cell DTX/DRX configuration is activated.

For the UE 110, the number of the configuration for SPS/CG occasions may be at least one, and in the FIG. 1, configurations 172A, 172B, and 172C for SPS/CG occasions are shown as examples. In the operation 170, the network device 150 may configure in the one or more configurations for SPS/CG occasions, respective one or more adaptation rules for the UE 110 to adapt the SPS/CG occasions. In the FIG. 1, adaptation rules 173, 175, 177 and 179 are shown as examples.

The mapping between the one or more configurations for SPS/CG occasions and the one or more adaptation rules may be one-to-one, one-to multiple and multiple to one. For example, the adaption rule 173 may correspond to the SPS/CG configurations 172A and 172B, the adaption rules 175, 177 and 179 may corresponding to the SPS/CG configuration 172C. The network device 150 may transmit the one or more configurations 172A, 172B, and 172C for SPS/CG occasions to the UE 110.

In an operation 120, based on the activation of the cell DTX/DRX configuration out of the at least one cell DTX/DRX configuration, the UE 110 may apply at least one configuration for SPS/CG occasions out of the one or more configurations for SPS/CG occasions which is associated with the activated cell DTX/DRX configuration. For example, in a case where in the operation 115 the UE 110 determines the activation of the DTX/DRX configuration 160B, if out of the configurations 172A, 172B, and 172C for SPS/CG occasions, the configurations 172A and 172B for SPS/CG occasions are associated with the DTX/DRX configuration 160B, in the operation 120, the UE 110 may apply the configurations 172A and 172B for SPS/CG occasions.

Such association information may be configured by the network device 150 and transmitted to the UE 110 with the cell DTX/DRX configurations 160A, 160B and 160C, with the configurations 172A, 172B, and 172C for SPS/CG occasions, or separately from the cell DTX/DRX configurations 160A, 160B and 160C and the configurations 172A, 172B, and 172C for SPS/CG occasions.

In an operation 185, based on the activation of the cell DTX/DRX configuration out of the at least one cell DTX/DRX configuration, the network device 150 may apply at least one configuration for SPS/CG occasions out of the one or more configurations for SPS/CG occasions which is associated with the activated cell DTX/DRX configuration. The network device 150 may perform the operation 185 correspondingly to the operation 120, such that the adaptation of the SPS/CG occasions may be synchronized on the network device 150 and the UE 110.

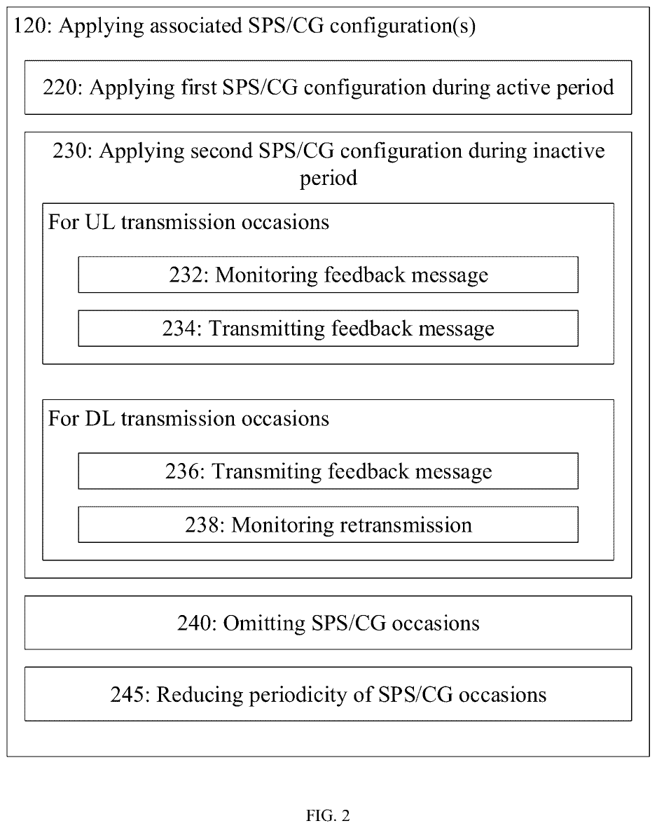

FIG. 2 shows an exemplary flow for applying SPS/CG configuration(s) according to the example embodiments of the present disclosure. In the FIG. 2, example operations performed in the operation 120 are shown, and it may be appreciated that the network device 150 may perform the corresponding example operations in the operation 185.

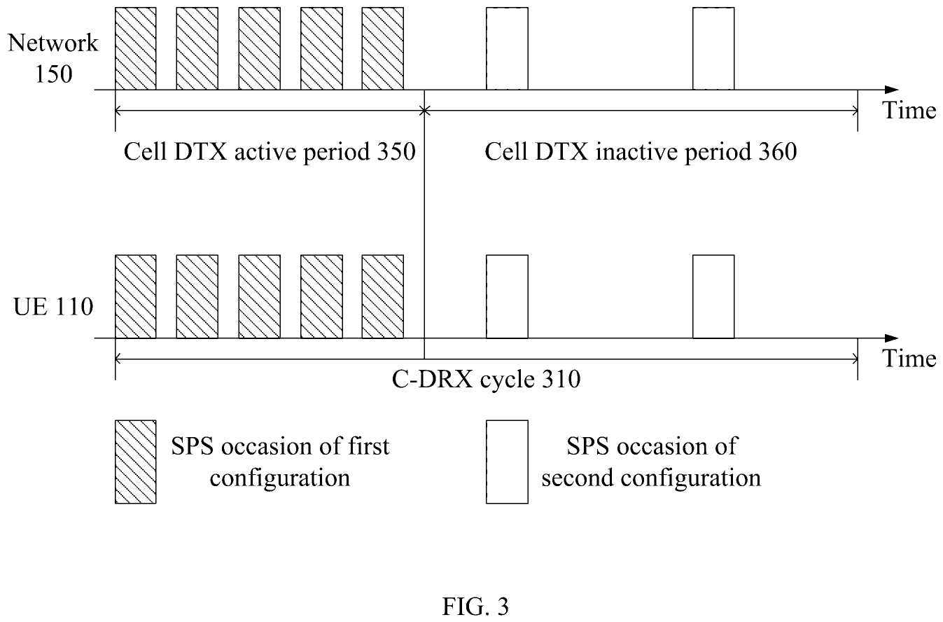

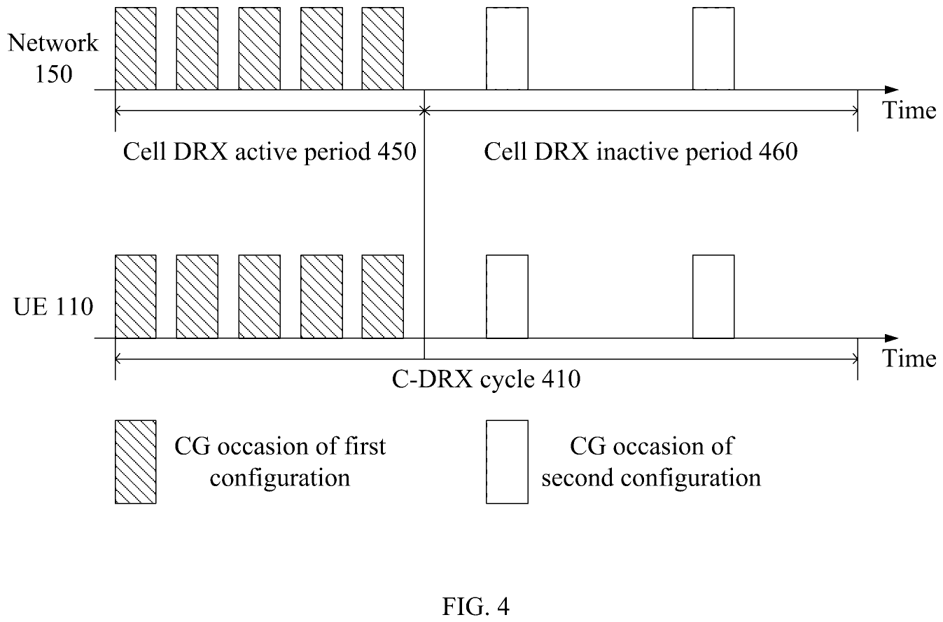

FIG. 3 shows examples of cell DTX patterns and configurations for SPS occasions. FIG. 4 shows examples of cell DRX patterns and configurations for CG occasions. In a case where the configurations 172A and 172B for SPS/CG occasions are associated with the currently activated DTX/DRX configuration 160B, in the operation 120, the UE 110 may be configured to apply the configurations 172A and 172B for SPS/CG occasions.

As is shown in the FIG. 3, it may be assumed that the configuration 172A for SPS occasions may be for example the first configuration for SPS occasions, and the configuration 172B for SPS occasions may be for example the second configuration for SPS occasions. As is shown in the FIG. 4, it may be assumed that the configuration 172A for CG occasions may be for example the first configuration for CG occasions, and the configuration 172B for CG occasions may be for example the second configuration for CG occasions.

The SPS occasions of the first configuration 172A for SPS occasions are more frequent than the SPS occasions of the second configuration 172B for SPS occasions. The CG occasions of the first configuration 172A for CG occasions are more frequent than the CG occasions of the second configuration 172B for CG occasions.

As is shown in the FIG. 3, cell DTX active period 350 and cell DTX inactive period 360 are applied on top of the C-DRX cycle 310 of the UE 110. As is shown in the FIG. 4, cell DRX active period 450 and cell DRX inactive period 460 are applied on top of the C-DRX cycle 410 of the UE 110.

In some embodiments, in the operation 170, the network device 150 may configure the UE 110 to apply the first configuration 172A for SPS occasions during the cell DTX active period 350 and configure the UE 110 to apply the second configuration 172B for SPS occasions during the cell DTX inactive period 360. In this case, UE 110 is configured to apply the first configuration 172A for SPS occasions during the cell DTX active period 350 in an operation 220 and configured to apply the second configuration 172B for SPS occasions during the cell DTX active period 360 in an operation 230.

In some embodiments, in the operation 170, the network device 150 may configure the UE 110 to apply the first configuration 172A for CG occasions during the cell DRX active period 450 and configure the UE 110 to apply the second configuration 172B for CG occasions during the cell DRX inactive period 460. In this case, UE 110 is configured to apply the first configuration 172A for CG occasions during the cell DRX active period 450 in an operation 220 and configured to apply the second configuration 172B for CG occasions during the cell DRX active period 460 in an operation 230.

The first configuration 172A may be adequate for better QoS, for example, the traffic with high QoS requirements.

Thus, when the cell DTX active period 350 expires, the UE 110 may autonomously switch from the first configuration 172A for SPS occasions to the second configuration 172B for SPS occasions, and when the cell DRX active period 450 expires, the UE 110 may autonomously switch from the first configuration 172A for CG occasions to the second configuration 172B for CG occasions. It may be appreciated that the active period 350 and the inactive period 360 are cyclically repeated, assuming that the adaption rule 173 corresponds to the SPS/CG configurations 172A and 172B, the UE 110 may autonomously switch between the first configuration 172A and the second configuration 172B according to the adaption rule 173.

In some embodiments, in the operation 170, the network device 150 may configure a timer 180 in the second configuration 172B for the UE 110 to monitor/transmit feedback message. The timer 180 may be referred to as inactivity timer. In a case where the UE 110 receives/transmits data using SPS/CG occasions during the cell DTX/DRX inactive period 360/460, the UE 110 may implement, e.g. start, the timer 180 for monitoring/transmitting the feedback message from/to the network device when the timer 180 is running. The feedback message may be for example hybrid automatic repeat request (HARQ) feedback message in the embodiments described herein.

For example, in a case where the UE 110 applies the second configuration 172B for UL transmission occasions e.g. CG occasions, in an operation 232, the UE 110 may implement the timer 180 after transmitting data according to the CG occasions, and monitor the feedback message from the network device 150 when the timer 180 is running.

In some embodiments, in the operation 170, additionally, the network device 150 may configure in the second configuration 172B a delay 182 proportional to a transition time of the network device 150 from a sleep state to an active state during the DTX/DRX inactive period 360/460. For the UE 110, the delay 182 is predetermined delay. In the operation 232 the UE 110 may implement the delay 182 into the timer 180. For example, in a case where the UE 110 applies the second configuration 172B for CG occasions, if a CG occasion occurs during the cell DRX inactive period 460, in the operation 232, the UE 110 may postpone the timer 180 by the delay 182. The “postpone” may alternatively be referred to as “suspend”. In this case, in the operation 232, the UE 110 may suspend the timer 180 by the delay 182. During the delay 182, the network device 150 can wake up from the sleep state to the active state. In other words, the delay may define a time it takes for the cell (the network device 150) to switch from an inactive (sleep) state to the active state during the inactive period.

In some embodiments, in an operation 234, during the cell DRX inactive period 460, the UE 110 may transmit to the network device 150 a feedback message corresponding to multiple transmission occasions e.g. SPS occasions. In some embodiment, during the cell DTX inactive period 360, and the network device 150 may transmit to the UE 110 a feedback message 190 corresponding to multiple CG occasions. Alternatively, the UE 110 may transmit to the network device 150 a feedback message corresponding to a transmission occasion during the inactive period or the next active period of the activated discontinuous communication configuration.

Alternatively or additionally, for example, in the operation 234, the UE 110 may transmit to the network device 150 the feedback message corresponding to multiple SPS occasions, during the next cell DRX active period 450, e.g. the start of the next cell DRX active period 450, and/or the network device 150 may transmit to the UE 110 the feedback message 190 corresponding to multiple CG occasions, during the next cell DTX active period 350, e.g. the start of the next cell DTX active period 350.

Thus, the feedback occasions during the cell DTX/DRX inactive period 360/460 may be less frequent than during the cell DTX/DRX active period. However, there may still be feedback occasions in both inactive and active periods.

For example, in a case where the UE 110 applies the second configuration 172B for DL transmission occasions, e.g. SPS occasions, the UE 110 may implement the timer 180 after receiving data according to the SPS occasions by transmitting to the network device 150 a feedback message related to a DL transmission occasion, e.g. a SPS occasion in an operation 236 and monitoring a retransmission from the network device 150 when the timer 180 is running.

In some embodiments, in a case where the UE 110 applies the second configuration 172B for SPS occasions, if the SPS occasion occurs during the cell DTX inactive period 360, in the operation 236, the UE 110 may postpone the timer 180 by the delay 182.

In some embodiments, when the UE 110 is in a DRX mode, the timer 180 may be a DRX retransmission timer of the UE. Following to the standard meaning, the DRX retransmission timer may refer to a time the UE 110 remains in the active state to wait for a downlink retransmission after the first possible retransmission occasion. When the UE 110 is not in the DRX mode, the timer 180 may have a different purpose and, optionally, a different duration.

In some embodiments, for example, in the operation 115, based on the activation timing 162C or the command 165, the UE 110 determine the activation of the cell DTX/DRX configurations 160C. Assuming that the cell DTX/DRX configurations 160C is associated with the SPS/CG configuration 172C, and the adaption rules 175, 177 and 179 corresponds to and are included in the SPS/CG configuration 172C, in the operation 120, the UE 110 may adapt the SPS/CG occasions according to the adaption rules 175, 177 and 179.

The adaptation of the SPS/CG occasions may include an operation 240, in which the UE 110 may omit at least part of the SPS/CG occasions of the configuration 172C during the during the cell DTX/DRX inactive period. For example, the adaption rule 175 may indicate the UE 110 to omit every N CG or SPS occasions during the cell DTX/DRX inactive period, e.g. every second occasion, an occasion out of 5 occasions, etc. Alternatively, for example, the adaption rule 175 may indicate that the first CG or SPS occasion after the start of the DTX/DTRX inactive period is omitted, or alternatively the adaption rule 175 may indicate the periodicity X and start offset y of the occasions to be omitted.

Alternatively or additionally, the adaptation of the SPS/CG occasions may include an operation 245, in which the UE 110 may reduce the periodicity of the SPS/CG occasions of the configuration 172C during a period before or after the cell DTX/DRX inactive period. For example, the adaption rule 177 may indicate the number of SPS/CG occasions to be higher shortly before or after the start of the cell DTX/DRX inactive period. For example, the periodicity of the SPS/CG occasions can be reduced to one half or one forth for a brief period of time shortly before/after the start of the cell DTX/DRX inactive period to provide additional CG and/or SPS occasions to the UE 110. The period may e.g. configured by the network device 150 in the adaption rule 177.

In some embodiments, the adaption rule 175 and/or the adaption rule 177 may indicate that if a frequency of the SPS/CG occasions is greater than a first threshold of the SPS/CG occasions, the adaption rule 175 and/or the adaption rule 177 are applicable, and if the frequency of the SPS/CG occasions is smaller than the first threshold of the SPS/CG occasions, the adaption rule 175 and/or the adaption rule 177 are inapplicable. The first threshold may be configured in the adaption rule 175 and/or the adaption rule 177 by the network device 150 in e.g. the operation 170.

In some embodiments, the adaption rule 179 may indicate that if the frequency of the SPS/CG occasions during the cell DTX/DRX inactive period is greater than a second threshold of the SPS/CG occasions, the UE 110 performs the operation 240 to omit of the at least part of the SPS/CG occasions. The second threshold may be configured in the adaption rule 179 by the network device 150 in e.g. the operation 170.

The network device 150 performs the adaption of the SPS/CG occasions synchronously with the UE 110.

Then, in an operation 130, the UE 110 may perform communication with the cell according to the applied at least one configuration for SPS/CG occasions. The communication may be for example transmission on the CG occasions and/or monitoring on the SPS occasions.

In some embodiments, in an operation 140, the UE 110 may refrain from transmitting a scheduling request (SR) or a buffer status report (BSR) in the CG occasions during the cell DTX/DRX inactive period.

According to the example embodiments of the present disclosure, a tradeoff between the NES gains and the UE performance e.g. in terms of delay and UE power consumption, may be achieved. The example embodiments of the present disclosure can minimize DL/UL activities during cell inactive periods and thus reduce energy consumption and can avoid wasting UE power consumption from useless SPS monitoring/CG transmission occasions. Further, the example embodiments of the present disclosure may also ensure that the QoS requirements can be met. Moreover, no extra signaling is required in the example embodiments of the present disclosure.

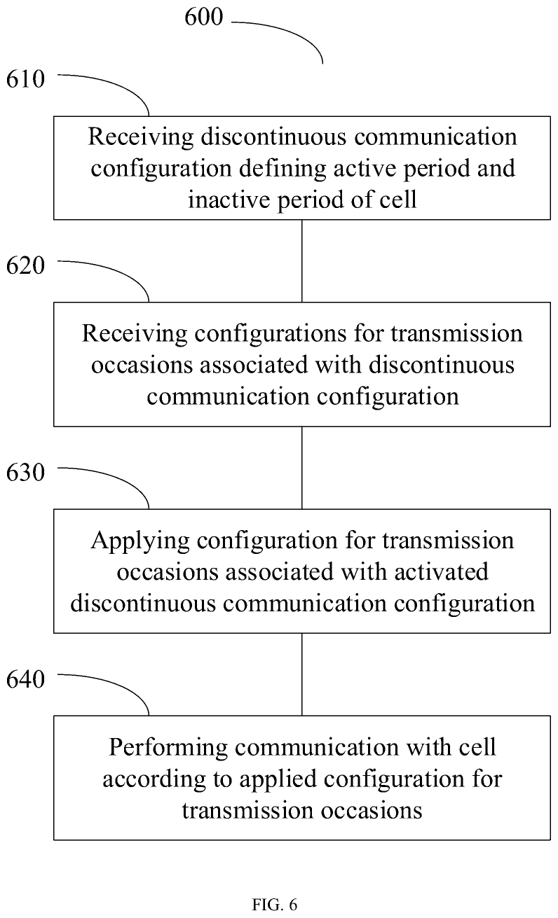

FIG. 6 shows a flow chart illustrating an example method 600 for adapting transmission occasions according to the example embodiments of the present disclosure. The example method 600 may be performed for example by an apparatus for a terminal device such as the UE 110.

Referring to the FIG. 6, the example method 600 may include an operation 610 of receiving from a network device serving the terminal device, at least one discontinuous communication configuration defining an active period and an inactive period of a cell; an operation 620 of receiving from the network device, one or more configurations for transmission occasions, the one or more configurations for transmission occasions being associated with the at least one discontinuous communication configuration; an operation 630 of based on activation of a discontinuous communication configuration out of the at least one discontinuous communication configuration, applying at least one configuration for transmission occasions out of the one or more configurations for transmission occasions which is associated with the activated discontinuous communication configuration; and an operation 640 of performing communication with the cell according to the applied at least one configuration for transmission occasions.

Details of the operation 610 have been described in the above descriptions with respect to at least the cell DTX/DRX configurations 160A, 160B and 160C, and repetitive descriptions thereof are omitted here.

Details of the operation 620 have been described in the above descriptions with respect to at least the SPS/CG configurations 172A, 172B and 172C, and the FIG. 5 and repetitive descriptions thereof are omitted here.

Details of the operation 630 have been described in the above descriptions with respect to at least the operation 120 and the FIG. 5, and repetitive descriptions thereof are omitted here.

Details of the operation 640 have been described in the above descriptions with respect to at least the operation 130, and repetitive descriptions thereof are omitted here.

In some example embodiments, the example method 600 may include an operation of determining the activation of the discontinuous communication configuration by receiving from the network device a command to activate the discontinuous communication configuration or based on an activation timing in the discontinuous communication configuration. The more details have been described in the above descriptions with respect to at least the operation 115, the activation timings 162A, 162B and 162C, and command 165, and repetitive descriptions thereof are omitted here.

In some example embodiments, the at least one configuration for transmission occasions may comprise a plurality of configurations for transmission occasions, and the example method 600 may include an operation of applying a first configuration for transmission occasions out of the plurality of configurations for transmission occasions during the active period of the activated discontinuous communication configuration, and applying a second configuration for transmission occasions out of the plurality of configurations for transmission occasions during the inactive period of the activated discontinuous communication configuration, and wherein the transmission occasions of the first configuration for transmission occasions may be more frequent than the transmission occasions of the second configuration for transmission occasions. The more details have been described in the above descriptions with respect to at least the operations 220 and 230, the FIG. 3 and the FIG. 4, and repetitive descriptions thereof are omitted here.

In some example embodiments, in a case where the second configuration for transmission occasions comprises an inactivity timer, the example method 600 may include an operation of applying the second configuration for uplink transmission occasions by at least performing: implementing the inactivity timer after transmitting data according to the uplink transmission occasions; and monitoring a feedback message from the network device when the inactivity timer is running. The more details have been described in the above descriptions with respect to at least the operation 232 and the timer 180 and repetitive descriptions thereof are omitted here.

In some example embodiments, the example method 600 may include an operation of if an uplink transmission occasion occurs during the inactive period of the activated discontinuous communication configuration, postponing the inactivity timer by a predetermined delay. The more details have been described in the above descriptions with respect to at least the operation 232, the timer 180 and the delay 182, and repetitive descriptions thereof are omitted here.

In some example embodiments, the example method 600 may include an operation of transmitting to the network device the feedback message corresponding to multiple transmission occasions during the inactive period of the activated discontinuous communication configuration. The more details have been described in the above descriptions with respect to at least the operation 234, and repetitive descriptions thereof are omitted here.

In some example embodiments, the example method 600 may include an operation of transmitting to the network device a feedback message corresponding to multiple transmission occasions during the next active period of the activated discontinuous communication configuration. The more details have been described in the above descriptions with respect to at least the operation 234, and repetitive descriptions thereof are omitted here.

In some example embodiments, in a case where the second configuration for transmission occasions comprises an inactivity timer, the example method 600 may include an operation of applying the second configuration for downlink transmission occasions by at least performing: implementing the inactivity timer after receiving data according to the downlink transmission occasions by transmitting to the network device a feedback message related to a downlink transmission occasion and monitoring a retransmission from the network device when the inactivity timer is running. The more details have been described in the above descriptions with respect to at least the operations 236 and 238 and the timer 180, and repetitive descriptions thereof are omitted here.

In some example embodiments, the example method 600 may include an operation of transmitting to the network device a feedback message corresponding to a transmission occasion during the inactive period or the next active period of the activated discontinuous communication configuration.

In some example embodiments, the example method 600 may include an operation of if the downlink transmission occasion occurs during the inactive period of the activated discontinuous communication configuration, postponing the inactivity timer by a predetermined delay. The more details have been described in the above descriptions with respect to at least the operation 236, the timer 180 and the delay 182, and repetitive descriptions thereof are omitted here.

In some example embodiments, the inactivity timer may be a DRX retransmission timer in a case where the apparatus is in a DRX mode. The more details have been described in the above descriptions with respect to at least the timer 180, and repetitive descriptions thereof are omitted here.

In some example embodiments, in a case where the at least one configuration for transmission occasions comprises one or more adaptation rules for adapting the transmission occasions, the applying of the at least one configuration for transmission occasions may comprise adapting the transmission occasions according to the one or more adaptation rules, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration. The more details have been described in the above descriptions with respect to at least the adaptation rules 173, 175, 177 and 179, and operations 240 and 245, and repetitive descriptions thereof are omitted here.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable. The more details have been described in the above descriptions with respect to at least the adaptation rules 173, 175, 177 and 179, and repetitive descriptions thereof are omitted here.

In some example embodiments, the one or more adaptation rules may indicate: if the frequency of the transmission occasions during the inactive period is greater than a second threshold of the transmission occasions, performing said omitting of the at least part of the transmission occasions. The more details have been described in the above descriptions with respect to at least the adaptation rules 173, 175, 177 and 179, and operation 240, and repetitive descriptions thereof are omitted here.

In some example embodiments, the example method 600 may include an operation of refraining from transmitting a SR or a BSR in the transmission occasions during the inactive period of the activated discontinuous communication configuration. The more details have been described in the above descriptions with respect to at least the operation 140, and repetitive descriptions thereof are omitted here.

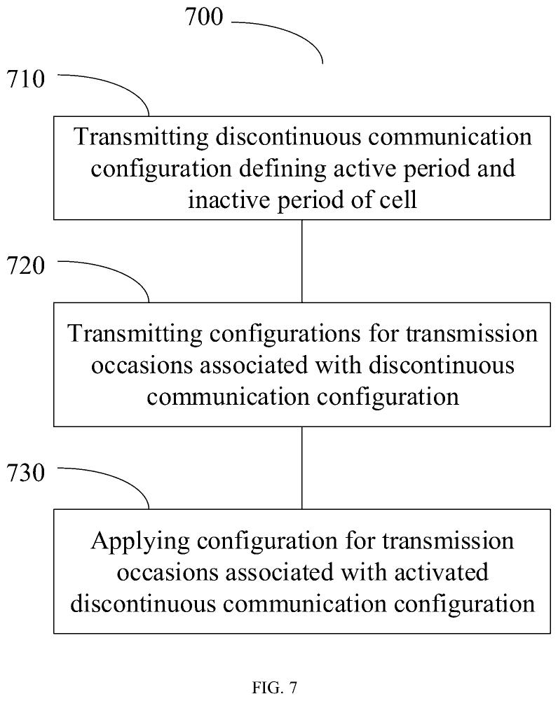

FIG. 7 shows a flow chart illustrating an example method 700 for adapting transmission occasions according to the example embodiments of the present disclosure. The example method 700 may be performed for example by an apparatus for a network device such as the network device 150.

Referring to the FIG. 7, the example method 700 may include an operation 710 of transmitting to a terminal device served by the network device, at least one discontinuous communication configuration defining an active period and an inactive period of a cell; an operation 720 of transmitting to the terminal device, one or more configurations for transmission occasions, the one or more configurations for transmission occasions being associated with the at least one discontinuous communication configuration; and an operation 720 of based on activation of a discontinuous communication configuration out of the at least one discontinuous communication configuration, applying at least one configuration for transmission occasions out of the one or more configurations for transmission occasions which is associated with the activated discontinuous communication configuration.

Details of the operation 710 have been described in the above descriptions with respect to at least the cell DTX/DRX configurations 160A, 160B and 160C, and repetitive descriptions thereof are omitted here.

Details of the operation 720 have been described in the above descriptions with respect to at least the SPS/CG configurations 172A, 172B and 172C, and the FIG. 5 and repetitive descriptions thereof are omitted here.

Details of the operation 730 have been described in the above descriptions with respect to at least the operation 185 and the FIG. 5, and repetitive descriptions thereof are omitted here.

In some example embodiments, the example method 700 may include an operation of transmitting to the terminal device, a command for the terminal device to activate a discontinuous communication configuration out of the at least one discontinuous communication configuration; or an operation of configuring in the at least one discontinuous communication configuration, an activation timing for the terminal device to activate a discontinuous communication configuration out of the at least one discontinuous communication configuration. The more details have been described in the above descriptions with respect to at least the operation 155, the activation timings 162A, 162B and 162C, and command 165, and repetitive descriptions thereof are omitted here.

In some example embodiments, the at least one configuration for transmission occasions may comprise a plurality of configurations for transmission occasions, and the example method 700 may include an operation of configuring the terminal device to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, wherein the transmission occasions of the first configuration for transmission occasions may be more frequent than the transmission occasions of the second configuration for transmission occasions. The more details have been described in the above descriptions with respect to at least the operations 170, 220 and 230, the FIG. 3 and the FIG. 4, and repetitive descriptions thereof are omitted here.

In some example embodiments, the example method 700 may include an operation of configuring in the second configuration for transmission occasions, an inactivity timer for the terminal device to monitor a feedback message from the network device when the inactivity timer is running, and wherein the inactivity timer may be for the terminal device to implement after transmitting data according to uplink transmission occasions of the second configuration. The more details have been described in the above descriptions with respect to at least the operation 170 and the timer 180, and repetitive descriptions thereof are omitted here.

In some example embodiments, the example method 700 may include an operation of configuring in the second configuration for transmission occasions, a predetermined delay for the inactivity timer, wherein the predetermined delay may be for the terminal device to postpone the inactivity timer if an uplink transmission occasion occurs during the inactive period of the activated discontinuous communication configuration. The more details have been described in the above descriptions with respect to at least the operation 170, the timer 180 and the delay 182, and repetitive descriptions thereof are omitted here.

In some example embodiments, the example method 700 may include an operation of configuring in the second configuration for transmission occasions, an inactivity timer for the terminal device to transmit to the network device a feedback message when the inactivity timer is running, and wherein the inactivity timer may be for the terminal device to implement after receiving data according to downlink transmission occasions of the second configuration. The more details have been described in the above descriptions with respect to at least the operation 170 and the timer 180, and repetitive descriptions thereof are omitted here.

In some example embodiments, the example method 700 may include an operation of configuring in the second configuration for transmission occasions, a predetermined delay for the inactivity timer, wherein the predetermined delay may be for the terminal device to postpone the inactivity timer if a downlink transmission occasion occurs during the inactive period of the activated discontinuous communication configuration. The more details have been described in the above descriptions with respect to at least the operation 170, the timer 180 and the delay 182, and repetitive descriptions thereof are omitted here.

In some example embodiments, the inactivity timer may be a DRX retransmission timer, if the terminal device is in a DRX mode. The more details have been described in the above descriptions with respect to at least the timer 180, and repetitive descriptions thereof are omitted here.

In some example embodiments, the example method 700 may include an operation of transmitting to the terminal device the feedback message corresponding to multiple transmission occasions during the inactive period of the activated discontinuous communication configuration. The more details have been described in the above descriptions with respect to at least the feedback message 190, and repetitive descriptions thereof are omitted here.

In some example embodiments, the example method 700 may include an operation of transmitting to the terminal device the feedback message corresponding to multiple transmission occasions during the next active period of the activated discontinuous communication configuration. The more details have been described in the above descriptions with respect to at least the feedback message 190, and repetitive descriptions thereof are omitted here.

In some example embodiments, the example method 700 may include an operation of configuring in the one or more configurations for transmission occasions, respective one or more adaptation rules for the terminal device to adapt the transmission occasions, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration. The more details have been described in the above descriptions with respect to at least the adaptation rules 173, 175, 177 and 179, and operations 170, 240 and 245, and repetitive descriptions thereof are omitted here.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable. The more details have been described in the above descriptions with respect to at least the adaptation rules 173, 175, 177 and 179, and repetitive descriptions thereof are omitted here.

In some example embodiments, the one or more adaptation rules may indicate: if the frequency of the transmission occasions during the inactive period is greater than a second threshold of the transmission occasions, performing said omitting of the at least part of the transmission occasions. The more details have been described in the above descriptions with respect to at least the adaptation rules 173, 175, 177 and 179, and the operation 240, and repetitive descriptions thereof are omitted here.

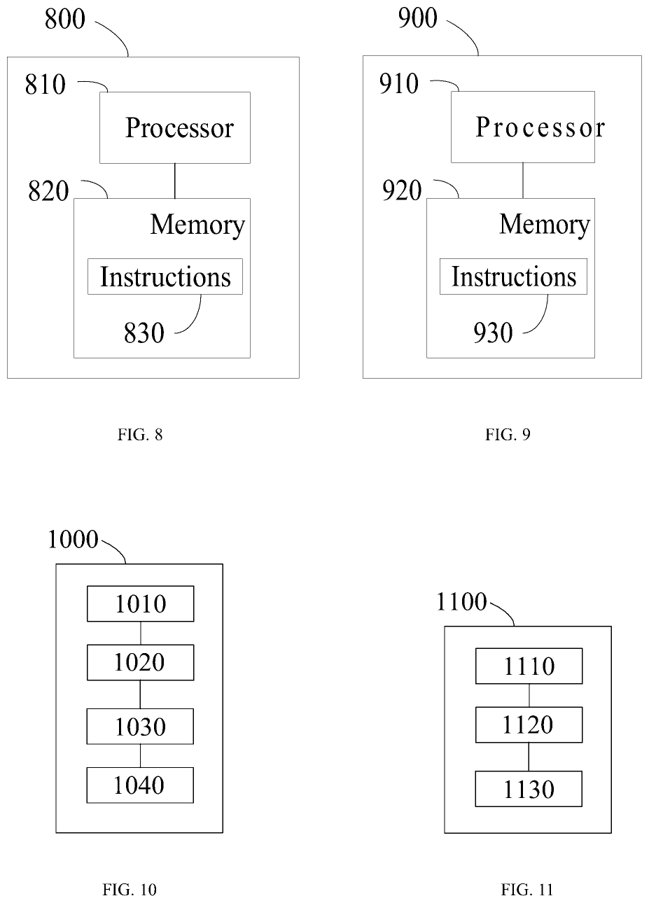

FIG. 8 shows a block diagram illustrating an example device 800 for adapting transmission occasions according to the example embodiments of the present disclosure. The device, for example, may be at least part of an apparatus for a terminal device such as the UE 110 in the above examples.

As shown in the FIG. 8, the example device 800 may include at least one processor 810 and at least one memory 820 that may store instructions 830. The instructions 830, when executed by the at least one processor 810, may cause the device 800 at least to perform the example method 600 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 800.

FIG. 9 shows a block diagram illustrating an example device 900 for adapting transmission occasions according to the example embodiments of the present disclosure. The device, for example, may be at least part of an apparatus for a network device such as the network device 150 in the above examples.

As shown in the FIG. 9, the example device 900 may include at least one processor 910 and at least one memory 920 that may store instructions 930. The instructions 930, when executed by the at least one processor 910, may cause the device 900 at least to perform the example method 700 described above.

In various example embodiments, the at least one processor 910 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 910 may also include at least one other circuitry or element not shown in the FIG. 9.

In various example embodiments, the at least one memory 920 in the example device 900 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 920 may include, but are not limited to, an electric, a magnetic, an optical, an electromagnetic, an infrared, or a semiconductor system, apparatus, or device or any combination of the above.

Further, in various example embodiments, the example device 900 may also include at least one other circuitry, element, and interface, for example at least one I/O interface, at least one antenna element, and the like.

In various example embodiments, the circuitries, parts, elements, and interfaces in the example device 900, including the at least one processor 910 and the at least one memory 920, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 150 is not limited to the above example device 900.

FIG. 10 shows a block diagram illustrating an example apparatus 1000 for adapting transmission occasions according to the example embodiments of the present disclosure. The apparatus, for example, may be at least part of a terminal device such as the UE 110 in the above examples.

As shown in FIG. 10, the example apparatus 1000 may include means 1010 for performing the operation 610 of the example method 600, means 1020 for performing the operation 620 of the example method 600, means 1030 for performing the operation 630 of the example method 600, and means 1040 for performing the operation 640 of the example method 600. In one or more another example embodiments, at least one I/O interface, at least one antenna element, and the like may also be included in the example apparatus 1000.

In some example embodiments, the apparatus may be configured to: determine the activation of the discontinuous communication configuration by receiving from the network device a command to activate the discontinuous communication configuration or based on an activation timing in the discontinuous communication configuration.

In some example embodiments, the at least one configuration for transmission occasions may comprise a plurality of configurations for transmission occasions, and the apparatus may be configured to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, and wherein the transmission occasions of the first configuration for transmission occasions may be more frequent than the transmission occasions of the second configuration for transmission occasions.

In some example embodiments, the apparatus may be configured to transmit to the network device a feedback message corresponding to a transmission occasion during the inactive period or the next active period of the activated discontinuous communication configuration.

In some example embodiments, in a case where the second configuration for transmission occasions comprises an inactivity timer, the apparatus may be configured to apply the second configuration for uplink transmission occasions by at least performing: implementing the inactivity timer after transmitting data according to the uplink transmission occasions; and monitoring a feedback message from the network device when the inactivity timer is running.

In some example embodiments, the apparatus may be configured to if an uplink transmission occasion occurs during the inactive period of the activated discontinuous communication configuration, postpone the inactivity timer by a predetermined delay.

In some example embodiments, the apparatus may be configured to transmit to the network device the feedback message corresponding to multiple transmission occasions during the inactive period of the activated discontinuous communication configuration.

In some example embodiments, the apparatus may be configured to transmit to the network device a feedback message corresponding to multiple transmission occasions during the next active period of the activated discontinuous communication configuration.

In some example embodiments, in a case where the second configuration for transmission occasions comprises an inactivity timer, the apparatus may be configured to apply the second configuration for downlink transmission occasions by at least performing: implementing the inactivity timer after receiving data according to the downlink transmission occasions by transmitting to the network device a feedback message related to a downlink transmission occasion and monitoring a retransmission from the network device when the inactivity timer is running.

In some example embodiments, the apparatus may be configured to if the downlink transmission occasion occurs during the inactive period of the activated discontinuous communication configuration, postpone the inactivity timer by a predetermined delay.

In some example embodiments, the inactivity timer may be a DRX retransmission timer in a case where the apparatus is in a DRX mode.

In some example embodiments, in a case where the at least one configuration for transmission occasions comprises one or more adaptation rules for adapting the transmission occasions, the applying of the at least one configuration for transmission occasions may comprise adapting the transmission occasions according to the one or more adaptation rules, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable.

In some example embodiments, the one or more adaptation rules may indicate: if the frequency of the transmission occasions during the inactive period is greater than a second threshold of the transmission occasions, performing said omitting of the at least part of the transmission occasions.

In some example embodiments, the apparatus may be configured to refrain from transmitting a SR or a BSR in the transmission occasions during the inactive period of the activated discontinuous communication configuration.

In some example embodiments, examples of means in the example apparatus 1000 may include circuitries. For example, an example of means 1010 may include a circuitry configured to perform the operation 610 of the example method 600, an example of means 1020 may include a circuitry configured to perform the operation 620 of the example method 600, an example of means 1030 may include a circuitry configured to perform the operation 630 of the example method 600, and an example of means 1040 may include a circuitry configured to perform the operation 640 of the example method 600.

The example apparatus 1000 may further include means comprising circuitry configured to perform the example method 600. In some example embodiments, examples of means may also include software modules and any other suitable function entities.

FIG. 11 shows a block diagram illustrating an example apparatus 1100 for adapting transmission occasions according to the example embodiments of the present disclosure. The apparatus, for example, may be at least part of a network device such as the network device 150 in the above examples.

As shown in FIG. 11, the example apparatus 1100 may include means 1110 for performing the operation 710 of the example method 700, means 1120 for performing the operation 720 of the example method 700, and means 1130 for performing the operation 730 of the example method 700. In one or more another example embodiments, at least one I/O interface, at least one antenna element, and the like may also be included in the example apparatus 1100.

In some example embodiments, the apparatus may be configured to transmit to the terminal device, a command for the terminal device to activate a discontinuous communication configuration out of the at least one discontinuous communication configuration; or configure in the at least one discontinuous communication configuration, an activation timing for the terminal device to activate a discontinuous communication configuration out of the at least one discontinuous communication configuration.

In some example embodiments, the at least one configuration for transmission occasions may comprise a plurality of configurations for transmission occasions, and the apparatus may be configured to configure the terminal device to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, wherein the transmission occasions of the first configuration for transmission occasions may be more frequent than the transmission occasions of the second configuration for transmission occasions.

In some example embodiments, the apparatus may be configured to configure in the second configuration for transmission occasions, an inactivity timer for the terminal device to monitor a feedback message from the network device when the inactivity timer is running, and wherein the inactivity timer may be for the terminal device to implement after transmitting data according to uplink transmission occasions of the second configuration.

In some example embodiments, the apparatus may be configured to configure in the second configuration for transmission occasions, a predetermined delay for the inactivity timer, wherein the predetermined delay may be for the terminal device to postpone the inactivity timer if an uplink transmission occasion occurs during the inactive period of the activated discontinuous communication configuration.

In some example embodiments, the apparatus may be configured to configure in the second configuration for transmission occasions, an inactivity timer for the terminal device to transmit to the network device a feedback message when the inactivity timer is running, and wherein the inactivity timer may be for the terminal device to implement after receiving data according to downlink transmission occasions of the second configuration.

In some example embodiments, the apparatus may be configured to configure in the second configuration for transmission occasions, a predetermined delay for the inactivity timer, wherein the predetermined delay may be for the terminal device to postpone the inactivity timer if a downlink transmission occasion occurs during the inactive period of the activated discontinuous communication configuration.

In some example embodiments, the inactivity timer may be a DRX retransmission timer, if the terminal device is in a DRX mode.

In some example embodiments, the apparatus may be configured to transmit to the terminal device the feedback message corresponding to multiple transmission occasions during the inactive period of the activated discontinuous communication configuration.

In some example embodiments, the apparatus may be configured to transmit to the terminal device the feedback message corresponding to multiple transmission occasions during the next active period of the activated discontinuous communication configuration.

In some example embodiments, the apparatus may be configured to configure in the one or more configurations for transmission occasions, respective one or more adaptation rules for the terminal device to adapt the transmission occasions, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable.

In some example embodiments, the one or more adaptation rules may indicate: if the frequency of the transmission occasions during the inactive period is greater than a second threshold of the transmission occasions, performing said omitting of the at least part of the transmission occasions.

In some example embodiments, examples of means in the example apparatus 1100 may include circuitries. For example, an example of means 1110 may include a circuitry configured to perform the operation 710 of the example method 700, an example of means 1120 may include a circuitry configured to perform the operation 720 of the example method 700, and an example of means 1130 may include a circuitry configured to perform the operation 730 of the example method 700.

The example apparatus 1100 may further include means comprising circuitry configured to perform the example method 800. In some example embodiments, examples of means may also include software modules and any other suitable function entities.

The example embodiments of the present disclosure also provide a computer readable medium comprising program instructions that, when executed by an apparatus for a terminal device such as the UE 110 in the above examples, may cause the terminal device at least to perform: receiving from a network device serving the terminal device, at least one discontinuous communication configuration defining an active period and an inactive period of a cell; receiving from the network device, one or more configurations for transmission occasions, the one or more configurations for transmission occasions being associated with the at least one discontinuous communication configuration; based on activation of a discontinuous communication configuration out of the at least one discontinuous communication configuration, applying at least one configuration for transmission occasions out of the one or more configurations for transmission occasions which is associated with the activated discontinuous communication configuration; and performing communication with the cell according to the applied at least one configuration for transmission occasions.

In some example embodiments, the apparatus may be configured to: determine the activation of the discontinuous communication configuration by receiving from the network device a command to activate the discontinuous communication configuration or based on an activation timing in the discontinuous communication configuration.

In some example embodiments, the at least one configuration for transmission occasions may comprise a plurality of configurations for transmission occasions, and the apparatus may be configured to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, and wherein the transmission occasions of the first configuration for transmission occasions may be more frequent than the transmission occasions of the second configuration for transmission occasions.

In some example embodiments, the apparatus may be configured to transmit to the network device a feedback message corresponding to a transmission occasion during the inactive period or the next active period of the activated discontinuous communication configuration.

In some example embodiments, in a case where the second configuration for transmission occasions comprises an inactivity timer, the apparatus may be configured to apply the second configuration for uplink transmission occasions by at least performing: implementing the inactivity timer after transmitting data according to the uplink transmission occasions; and monitoring a feedback message from the network device when the inactivity timer is running.

In some example embodiments, the apparatus may be configured to if an uplink transmission occasion occurs during the inactive period of the activated discontinuous communication configuration, postpone the inactivity timer by a predetermined delay.

In some example embodiments, the apparatus may be configured to transmit to the network device the feedback message corresponding to multiple transmission occasions during the inactive period of the activated discontinuous communication configuration.

In some example embodiments, the apparatus may be configured to transmit to the network device a feedback message corresponding to multiple transmission occasions during the next active period of the activated discontinuous communication configuration.

In some example embodiments, in a case where the second configuration for transmission occasions comprises an inactivity timer, the apparatus may be configured to apply the second configuration for downlink transmission occasions by at least performing: implementing the inactivity timer after receiving data according to the downlink transmission occasions by transmitting to the network device a feedback message related to a downlink transmission occasion and monitoring a retransmission from the network device when the inactivity timer is running.

In some example embodiments, the apparatus may be configured to if the downlink transmission occasion occurs during the inactive period of the activated discontinuous communication configuration, postpone the inactivity timer by a predetermined delay.

In some example embodiments, the inactivity timer may be a DRX retransmission timer in a case where the apparatus is in a DRX mode.

In some example embodiments, in a case where the at least one configuration for transmission occasions comprises one or more adaptation rules for adapting the transmission occasions, the applying of the at least one configuration for transmission occasions may comprise adapting the transmission occasions according to the one or more adaptation rules, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable.

In some example embodiments, the one or more adaptation rules may indicate: if the frequency of the transmission occasions during the inactive period is greater than a second threshold of the transmission occasions, performing said omitting of the at least part of the transmission occasions.

In some example embodiments, the apparatus may be configured to refrain from transmitting a SR or a BSR in the transmission occasions during the inactive period of the activated discontinuous communication configuration.

The example embodiments of the present disclosure also provide a computer readable medium comprising program instructions that, when executed by an apparatus for a network device such as the network device 150 in the above examples, may cause the network device at least to perform: transmitting to a terminal device served by the network device, at least one discontinuous communication configuration defining an active period and an inactive period of a cell; transmitting to the terminal device, one or more configurations for transmission occasions, the one or more configurations for transmission occasions being associated with the at least one discontinuous communication configuration; and based on activation of a discontinuous communication configuration out of the at least one discontinuous communication configuration, applying at least one configuration for transmission occasions out of the one or more configurations for transmission occasions which is associated with the activated discontinuous communication configuration.

In some example embodiments, the apparatus may be configured to transmit to the terminal device, a command for the terminal device to activate a discontinuous communication configuration out of the at least one discontinuous communication configuration; or configure in the at least one discontinuous communication configuration, an activation timing for the terminal device to activate a discontinuous communication configuration out of the at least one discontinuous communication configuration.

In some example embodiments, the at least one configuration for transmission occasions may comprise a plurality of configurations for transmission occasions, and the apparatus may be configured to configure the terminal device to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, wherein the transmission occasions of the first configuration for transmission occasions may be more frequent than the transmission occasions of the second configuration for transmission occasions.

In some example embodiments, the apparatus may be configured to configure in the second configuration for transmission occasions, an inactivity timer for the terminal device to monitor a feedback message from the network device when the inactivity timer is running, and wherein the inactivity timer may be for the terminal device to implement after transmitting data according to uplink transmission occasions of the second configuration.

In some example embodiments, the apparatus may be configured to configure in the second configuration for transmission occasions, a predetermined delay for the inactivity timer, wherein the predetermined delay may be for the terminal device to postpone the inactivity timer if an uplink transmission occasion occurs during the inactive period of the activated discontinuous communication configuration.

In some example embodiments, the apparatus may be configured to configure in the second configuration for transmission occasions, an inactivity timer for the terminal device to transmit to the network device a feedback message when the inactivity timer is running, and wherein the inactivity timer may be for the terminal device to implement after receiving data according to downlink transmission occasions of the second configuration.

In some example embodiments, the apparatus may be configured to configure in the second configuration for transmission occasions, a predetermined delay for the inactivity timer, wherein the predetermined delay may be for the terminal device to postpone the inactivity timer if a downlink transmission occasion occurs during the inactive period of the activated discontinuous communication configuration.

In some example embodiments, the inactivity timer may be a DRX retransmission timer, if the terminal device is in a DRX mode.

In some example embodiments, the apparatus may be configured to transmit to the terminal device the feedback message corresponding to multiple transmission occasions during the inactive period of the activated discontinuous communication configuration.

In some example embodiments, the apparatus may be configured to transmit to the terminal device the feedback message corresponding to multiple transmission occasions during the next active period of the activated discontinuous communication configuration.

In some example embodiments, the apparatus may be configured to configure in the one or more configurations for transmission occasions, respective one or more adaptation rules for the terminal device to adapt the transmission occasions, and the adapting of the transmission occasions may comprise at least one of the following: omitting at least part of transmission occasions of the at least one configuration for transmission occasions during the inactive period of the activated discontinuous communication configuration; or reducing the periodicity of transmission occasions of the at least one configuration for transmission occasions during a period before or after the inactive period of the activated discontinuous communication configuration.

In some example embodiments, the one or more adaptation rules may indicate: if a frequency of the transmission occasions is greater than a first threshold of the transmission occasions, the one or more adaptation rules are applicable, and if the frequency of the transmission occasions is smaller than the first threshold of the transmission occasions, the one or more adaptation rules are inapplicable.

In some example embodiments, the one or more adaptation rules may indicate: if the frequency of the transmission occasions during the inactive period is greater than a second threshold of the transmission occasions, performing said omitting of the at least part of the transmission occasions.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,”“for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BSR buffer status report
C-DRX connected discontinuous reception
CG configured grant
DL downlink
DRX discontinuous reception
DTX discontinuous transmission
HARQ hybrid automatic repeat request
NES network energy saving
NW network
PDSCH physical downlink shared channel
PUSCH physical uplink shared channel
QoS quality of service
SPS semi-persistent scheduling
SR scheduling request
UE user equipment
UL uplink
VoIP voice over internet protocol

1. An apparatus for a terminal device, comprising:
at least one processor; and
at least one memory storing instructions that, when executed by the at least one processor, cause the terminal device at least to perform:
receiving from a network device serving the terminal device, at least one discontinuous communication configuration defining an active period and an inactive period of a cell;
receiving from the network device, one or more configurations for transmission occasions, the one or more configurations for transmission occasions being associated with the at least one discontinuous communication configuration;
based on activation of a discontinuous communication configuration out of the at least one discontinuous communication configuration, applying at least one configuration for transmission occasions out of the one or more configurations for transmission occasions which is associated with the activated discontinuous communication configuration; and
performing communication with the cell according to the applied at least one configuration for transmission occasions.

2. The apparatus of claim 1, wherein the apparatus is configured to:
determine the activation of the discontinuous communication configuration by receiving from the network device a command to activate the discontinuous communication configuration or based on an activation timing in the discontinuous communication configuration.

3. The apparatus of claim 1, wherein the at least one configuration for transmission occasions comprises a plurality of configurations for transmission occasions, and the apparatus is configured to apply a first configuration for transmission occasions out of the plurality of configurations for transmission occasions during the active period of the activated discontinuous communication configuration, and to apply a second configuration for transmission occasions out of the plurality of configurations for transmission occasions during the inactive period of the activated discontinuous communication configuration, and wherein the transmission occasions of the first configuration for transmission occasions are more frequent than the transmission occasions of the second configuration for transmission occasions.

4. The apparatus of claim 3, wherein the apparatus is configured to transmit to the network device a feedback message corresponding to a transmission occasion during the inactive period or the next active period of the activated discontinuous communication configuration.

5. The apparatus of claim 3, wherein in a case where the second configuration for transmission occasions comprises an inactivity timer, and wherein the apparatus is configured to apply the second configuration for uplink transmission occasions by at least performing:
implementing the inactivity timer after transmitting data according to the uplink transmission occasions; and
monitoring a feedback message from the network device when the inactivity timer is running.

6. The apparatus of claim 5, wherein the apparatus is configured, if an uplink transmission occasion occurs during the inactive period of the activated discontinuous communication configuration, to postpone the inactivity timer by a predetermined delay.

7. The apparatus of claim 3, wherein the apparatus is configured to transmit to the network device the feedback message corresponding to multiple transmission occasions during the inactive period of the activated discontinuous communication configuration.

8. The apparatus of claim 3, wherein the apparatus is configured to transmit to the network device a feedback message corresponding to multiple transmission occasions during the next active period of the activated discontinuous communication configuration.

9. The apparatus of claim 3, wherein in a case where the second configuration for transmission occasions comprises an inactivity timer, and wherein the apparatus is configured to apply the second configuration for downlink transmission occasions by at least performing:
implementing the inactivity timer after receiving data according to the downlink transmission occasions by transmitting to the network device a feedback message related to a downlink transmission occasion and monitoring a retransmission from the network device when the inactivity timer is running.

10. The apparatus of claim 9, wherein the apparatus is configured, if the downlink transmission occasion occurs during the inactive period of the activated discontinuous communication configuration, to postpone the inactivity timer by a predetermined delay.

11. The apparatus of claim 9, wherein the inactivity timer is a discontinuous reception retransmission timer in a case where the apparatus is in a discontinuous reception mode.

12. The apparatus of claim 1, wherein in a case where the at least one configuration for transmission occasions comprises one or more adaptation rules for adapting the transmission occasions, the applying of the at least one configuration for transmission occasions comprises adapting the transmission occasions according to the one or more adaptation rules, and the adapting of the transmission occasions comprises at least one of the following:
omitting at least part of transmission occasions of the at least one configuration for transmission occasions during the inactive period of the activated discontinuous communication configuration; or
reducing the periodicity of transmission occasions of the at least one configuration for transmission occasions during a period before or after the inactive period of the activated discontinuous communication configuration.

13. The apparatus of claim 12, wherein the one or more adaptation rules indicate:
if a frequency of the transmission occasions is greater than a first threshold of the transmission occasions, the one or more adaptation rules are applicable, and
if the frequency of the transmission occasions is smaller than the first threshold of the transmission occasions, the one or more adaptation rules are inapplicable.

14. The apparatus of claim 12, wherein the one or more adaptation rules indicate:
if the frequency of the transmission occasions during the inactive period is greater than a second threshold of the transmission occasions, performing said omitting of the at least part of the transmission occasions.

15. The apparatus of claim 1, wherein the apparatus is configured to:
refrain from transmitting a scheduling request or a buffer status report in the transmission occasions during the inactive period of the activated discontinuous communication configuration.

16-28. (canceled)

29. A method performed by an apparatus for a terminal device, comprising:
receiving from a network device serving the terminal device, at least one discontinuous communication configuration defining an active period and an inactive period of a cell;
receiving from the network device, one or more configurations for transmission occasions, the one or more configurations for transmission occasions being associated with the at least one discontinuous communication configuration;
based on activation of a discontinuous communication configuration out of the at least one discontinuous communication configuration, applying at least one configuration for transmission occasions out of the one or more configurations for transmission occasions which is associated with the activated discontinuous communication configuration; and
performing communication with the cell according to the applied at least one configuration for transmission occasions.

30. The method of claim 29, comprising:
determining the activation of the discontinuous communication configuration by receiving from the network device a command to activate the discontinuous communication configuration or based on an activation timing in the discontinuous communication configuration.

31. The method of claim 29, wherein the at least one configuration for transmission occasions comprises a plurality of configurations for transmission occasions, and the method comprises applying a first configuration for transmission occasions out of the plurality of configurations for transmission occasions during the active period of the activated discontinuous communication configuration, and applying a second configuration for transmission occasions out of the plurality of configurations for transmission occasions during the inactive period of the activated discontinuous communication configuration, and wherein the transmission occasions of the first configuration for transmission occasions are more frequent than the transmission occasions of the second configuration for transmission occasions.

32-39. (canceled)

40. The method of claim 29, wherein in a case where the at least one configuration for transmission occasions comprises one or more adaptation rules for adapting the transmission occasions, the applying of the at least one configuration for transmission occasions comprises adapting the transmission occasions according to the one or more adaptation rules, and the adapting of the transmission occasions comprises at least one of the following:
omitting at least part of transmission occasions of the at least one configuration for transmission occasions during the inactive period of the activated discontinuous communication configuration; or
reducing the periodicity of transmission occasions of the at least one configuration for transmission occasions during a period before or after the inactive period of the activated discontinuous communication configuration.

41-42. (canceled)

43. The method of claim 29, wherein the apparatus is configured to:
refrain from transmitting a scheduling request or a buffer status report in the transmission occasions during the inactive period of the activated discontinuous communication configuration.

44-60. (canceled)
